(19) United States
(12) Patent Application Publication
(10) Pub. No.: US 2007/0259575 A1
(43) Pub. Date: Nov. 8, 2007

(54) CRIMP CONTACT

(76) Inventors: Jeffery P. Stowers, Mt. Sidney, VA (US); Darryl M. Ashby, Weyers Cave, VA (US); David L. Rocker, Charlottesville, VA (US); Edward J. Aleshevich, Waynesboro, VA (US)

Correspondence Address: 24IP LAW GROUP USA, PLLC, 12 E. LAKE DRIVE, ANNAPOLIS, MD, 21403, US

(21) Appl. No.: 11/456,611

(22) Filed: Jul. 11, 2006

Related U.S. Application Data
(60) Provisional application No. 60/746,414, filed on May 4, 2006.

(51) Int. Cl. H01R 4/10

(52) U.S. Cl. 439/877

(57) ABSTRACT

A contact pin that comprises an elongated body having a central axis and first and second ends, a plurality of flanges near the second end of the elongated body for connecting a wire to the body, a plurality of tabs on the body, the tabs being biased away from the central axis of the body and a plurality of protrusions displaced along the body from the tabs. The plurality of flanges may comprise a first pair of flanges for contacting a conducting portion of a wire and a second pair of flanges for connecting the contact pin to an insulator on the wire. The plurality of protrusions may comprise gimbals, which may be circular or any other shape. The plurality of protrusions may be located on the body of the contact pin near the second, or crimp end of the contact pin. Alternatively or additionally, at least one of the plurality of protrusions may be located on the body of the contact pin near the first, or contact end of the contact pin. In a preferred embodiment, the plurality of tabs may be located approximately at a midpoint of the contact pin.

### CROSS-REFERENCE TO RELATED APPLICATIONS

The present application claims the benefit of the filing date of U.S. Provisional Application Ser. No. 60/746,414 entitled “Crimp Contact,” and filed on May 4, 2006.

The above cross-referenced related application is hereby incorporated by reference herein in its entirety.

### STATEMENT REGARDING FEDERALLY SPONSORED RESEARCH OR DEVELOPMENT

Not applicable.

### BACKGROUND OF THE INVENTION

1. Field of the Invention

The present invention relates to electrical contacts for mass interconnect devices, and more specifically, to a new contact pin for insertion into an interface module.

2. Brief Description of the Related Art

Complex electrical systems, such as those found in computers, cars and airplanes, undergo rigorous testing. During design, development, production, and maintenance, engineers must test both critical performance characteristics and the overall functioning of such devices. Interface test connectors and adapters are used to join complex systems with test equipment at a common interface.

A variety of contacts for use in interfaces are known. One known type of electrical contact is referred to as a crimp contact. Such a contact has a contact end and a crimp end. The contact end is used to connect to or mate with an opposing contact. The crimp end is used to connect the contact to a wire. The crimp end typically would include one or more flanges or wings that may be folded, bent or “crimped” onto a wire. Since a variety of different manufacturers make crimp contacts, a variety of different tools exist for folding or crimping the flanges or wings over, around and/or onto a wire.

Known crimp contacts further may include locking tines or stop tines projecting from one or more sides of the contact to stake the contact to a housing for the contact. Basically, the locking tine will be compressed as the contact is inserted into its housing and then snap into a recess in the housing to thereby prevent the contact from coming out of the housing when the contact is connected to or “mated” to an opposing contact. Because these known locking tines typically are positioned somewhere in the middle portion of the contact, they further result in some degree of float in the contact.

With the insertion of the known contacts into a housing, the contact is free to move and is only constrained by the boundary of the housing body. This could allow the contact to be biased in a position which would cause free float to be taken up before the mating portion of the connector contact would come together, thus not optimizing the interface of the contact surfaces. In addition, the contact may be too loose to the connector housing and could be inadvertently dislodged from the connector body.

### SUMMARY OF THE INVENTION

The present invention comprises a plurality of gimbals, tabs or other protrusions near a crimp portion of a contact pin to allow for alignment and float of the contact. The surfaces of the gimbals or projections contact the surface of the housing thus creating floating alignment while also acting as interference of the contact to the connector body that provides resistance for the contact as not to dislodge from the connector body.

Further, the design of the crimp area with various relief and clearance in accordance with an embodiment of the present invention allows the crimp contact to be used with multiple crimp tools from various manufacturers. The features improve the straightness and strength of the contact.

In a preferred embodiment, the present invention is a contact pin that comprises an elongated body having a central axis and first and second ends, a plurality of flanges near the second end of the elongated body for connecting a wire to the body, a plurality of tabs on the body, the tabs being biased away from the central axis of the body and a plurality of protrusions displaced along the body from the tabs. The plurality of flanges may comprise a first pair of flanges for contacting a conducting portion of a wire and a second pair of flanges for connecting the contact pin to an insulator on the wire. The plurality of protrusions may comprise gimbals, which may be circular or any other shape. The plurality of protrusions may be located on the body of the contact pin near the second, or crimp end of the contact pin. Alternatively or additionally, at least one of the plurality of protrusions may be located on the body of the contact pin near the first, or contact end of the contact pin. In a preferred embodiment, the plurality of tabs may be located approximately at a midpoint of the contact pin. The tabs, however, may be located elsewhere on the contact pin, such as adjacent the crimp end of the contact pin or adjacent the contact end of the contact pin.

In another embodiment, the present invention is an assembly that comprises a housing having first and second sides and a plurality of channels there through, wherein at least one of the channels has at least one ridge therein and at least one surface therein; and a contact pin comprising a body, a first end for connecting to another contact, a second end for connecting to a wire, a tab for engaging with at least one ridge in the housing when the contact pin is inserted to the at least one channel, and a protrusion from the pin body for contacting with the at least one surface in the housing.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1 is a perspective view of a crimp contact in accordance with a preferred embodiment of the present invention.

FIG. 2 is a perspective view of a crimp contact in accordance with a preferred embodiment of the present invention with a wire connected thereto.

FIG. 3 is a perspective view of a crimp contact in accordance with a preferred embodiment of the present invention in a housing.

FIG. 4 is a cross-section of a housing having a crimp contact in accordance with a preferred embodiment of the present invention inserted therein.

FIG. 5 is a module into which a crimp contact in accordance with a preferred embodiment of the present invention may be inserted.

### DETAILED DESCRIPTION OF THE PREFERRED EMBODIMENTS

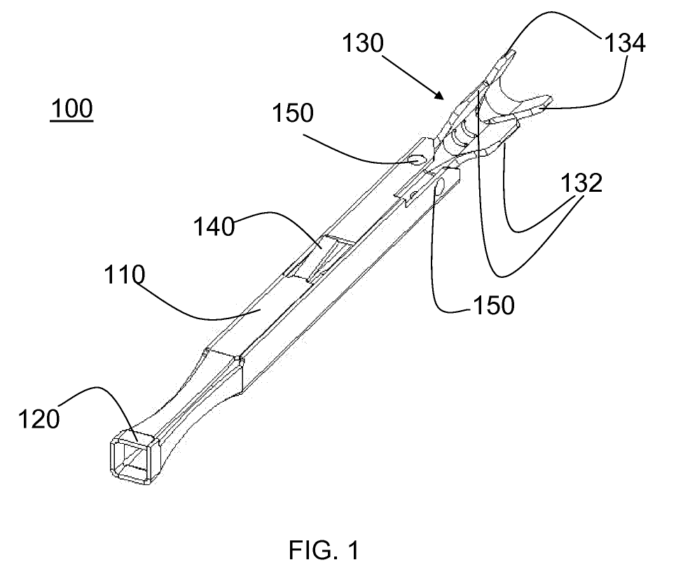

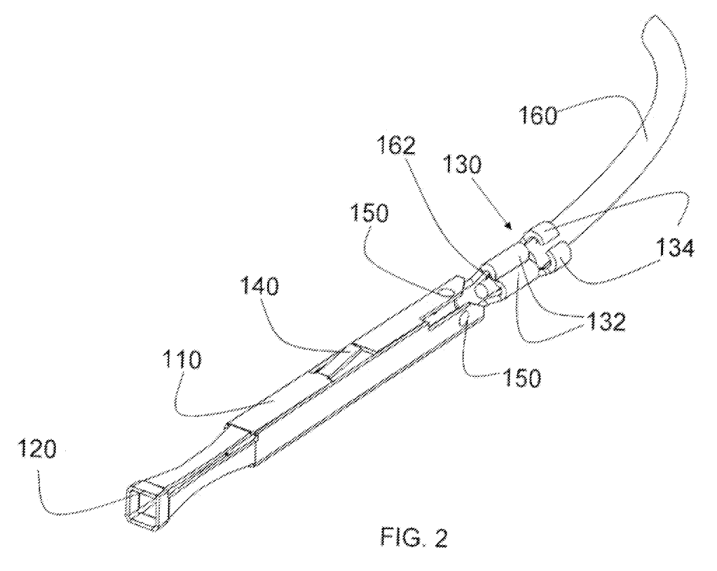

A preferred embodiment of a crimp contact in accordance with the present invention is described with reference to FIGS. 1-2. A crimp contact 100 has a body 110 with a contact end 120 to be mated with an opposing contact (not shown) and a crimp end 130 to be connected to a wire. Near the crimp end 130 of the contact 100 are a plurality of flanges 132, 134 for connecting the crimp contact to a wire 160. The flanges 132 are folded or crimped onto an exposed conductor 162 of a wire 160 using a crimp tool (not shown). The flanges 134 are folded or crimped around an insulator of wire 160 likewise using a crimp tool to further hold the wire in place and prevent inadvertent disconnection of the wire 160 from the contact 100. The flanges 132, 134 are designed to have widths and spaces or cutouts in between the flanges 132 and 134 to accommodate a plurality of crimp tools of different structures or designs. The crimp tools may be of any conventional type and will be known to those of skill in the art.

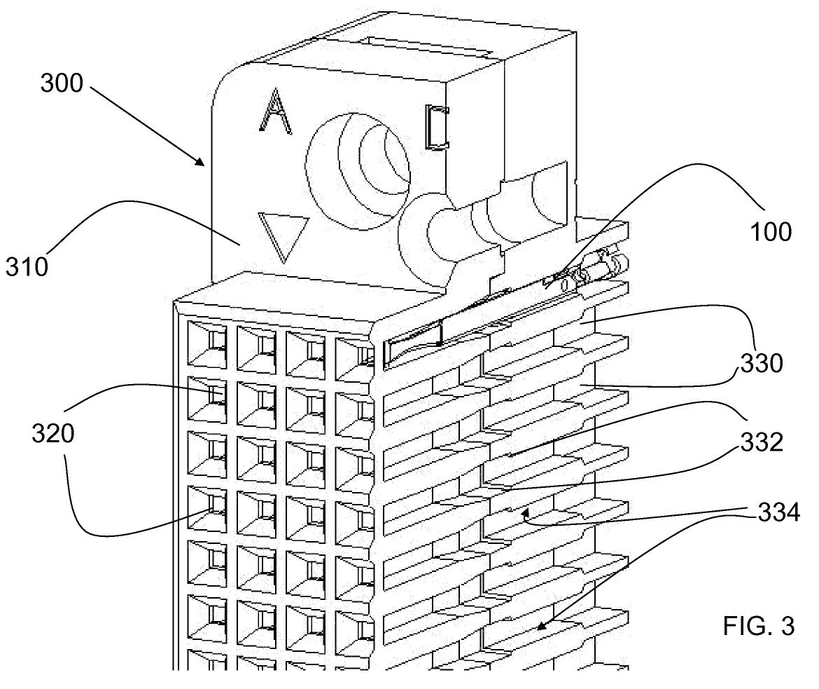

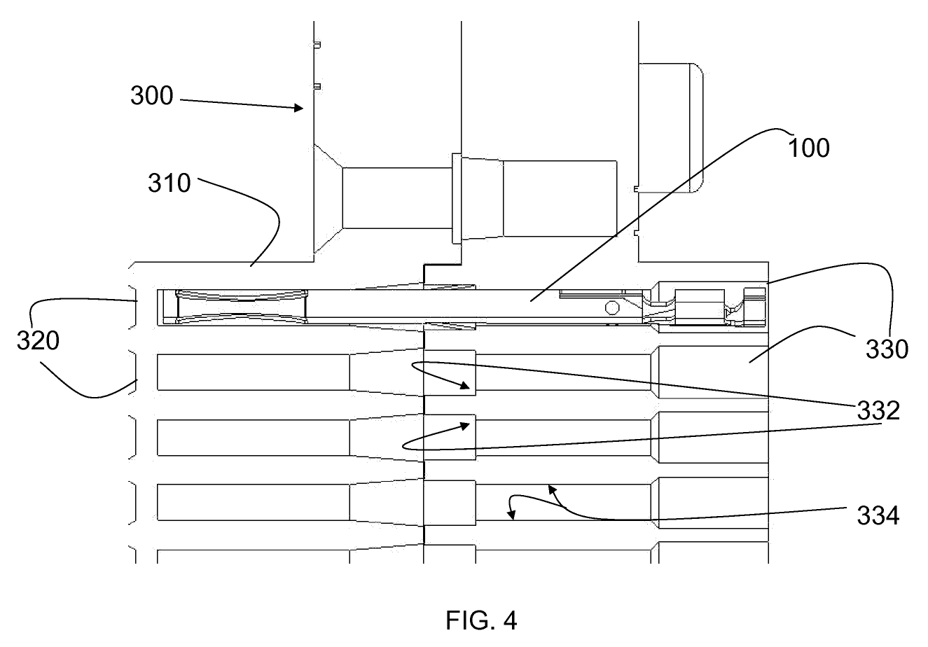

The contact 100 further has a pair of tabs 140 biased outward from the body 110 of the contact 100. As will be discussed with reference to FIGS. 3-4, the tabs 140 snap into or engage recesses, ridges, lips or grooves in a channel in a module or housing to prevent movement of the contact 100 backward out of the module or housing after the contact 100 has been inserted and to provide alignment and limited float of the contact 100 in the channel 330. In a preferred embodiment of the invention, the tabs 140 are located on a middle portion of the contact body 110.

The contact 100 has a plurality of gimbals or other protrusions 150 for aligning the contact 100 and for providing resistance against the sides of channel in a module to prevent the contact 100 from sliding or otherwise moving out of position in a module or other housing. While the gimbal and tab features of the invention are shown in the preferred embodiment on a crimp contact, other embodiments of the invention in which such features are used in connection with other types of contact pins will be apparent to those of skill in the art. Further, while the gimbals or protrusions 150 are shown in the preferred embodiment to be circular or rounded, other shapes and structures of gimbals or protrusions may be used.

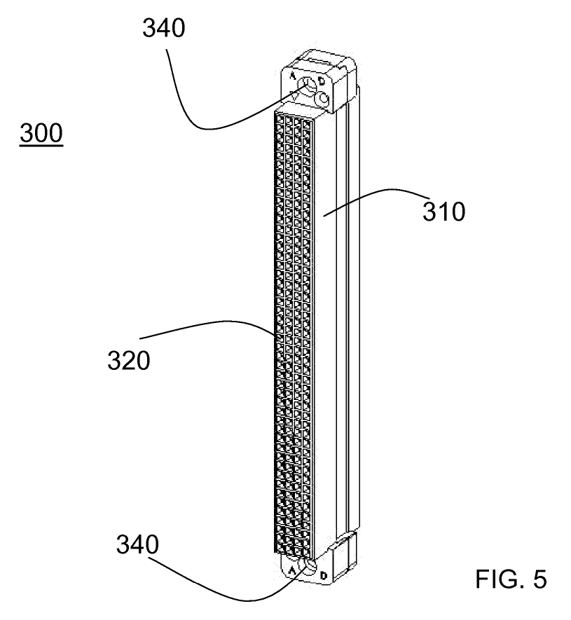

A crimp contact in accordance with a preferred embodiment of the present invention may be used in a module or housing 300, as shown in FIGS. 3-5. A typical module 300 has a body 310 and means such as holes 340 for mounting the module to, for example, an interface device for automatic test equipment. The module body 310 has a plurality of openings 320 in a face of the module such that contact in an opposing module may be inserted through the openings 320 to connect to contacts 100 in the module 300. Each opening 320 leads to a channel 330 for accommodating a contact pin 100.

A contact pin 100 is inserted into a channel 330 from a side of the module body 310 opposite the opening 320. As the contact 100 is pushed into the channel 320, the tabs 140 on the contact 100 are depressed toward the central axis of the contact pin 100. The channel 320 has a pair of ridges, grooves or indentations 332. As the contact 100 is pushed to a position in which the tabs 140 on the contact 100 pass the ridges 332, the tabs 140 press outward and engage the ridges 332, thereby preventing unwanted withdrawal of the contact 100. Additionally, as the contact is pushed into position, the gimbals 150 on the contact 100 contact surfaces 334 in the channel 330 thereby aligning the contacting end 120 of the contact 100 with the opening 320 in the module and providing resistance to unwanted movement of the contact within or out of the channel 330 in either direction in the channel.

In the preferred embodiment shown in FIGS. 1-5, the contact 100 is four-sided and is provided with a gimbal or protrusion 150 on each of the four sides. Those of skill in the art, however, will understand that other arrangements of the gimbals or protrusions are possible. For example, with a four-sided pin, the tabs 140 may be provided on one pair of opposing sides while gimbals 150 are provided on the other pair of opposing sides. Additional variations are possible and will be apparent to those of skill in the art. Similarly, in the preferred embodiment shown in FIGS. 1-4, the gimbals are located near the crimp end of a contact 100 and the tabs 140 are located near the midpoint of the contact 100. The gimbals 150 and tabs 140, however, may be located in different places on the contact and such other arrangements will be apparent to those of skill in the art.

Additionally, while a female contact pin is shown and described in connection with the preferred embodiment, the present invention may likewise be used with male contact pins.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

1. A contact pin comprising:
an elongated body having a central axis and first and second ends;
a plurality of flanges near said second end of said elongated body for connecting a wire to said body;
a plurality of tabs on said body, said tabs being biased away from said central axis of said body and being located near a midpoint along said body; and
a plurality of protrusions displaced along said body spaced from said tabs toward said flanges for providing resistance to forward and rearward longitudinal movement of said contact pin.

2. A contact pin according to claim 1 wherein said plurality of flanges comprises:
a first pair of flanges for contacting a conducting portion of a wire; and a second pair of flanges for connecting said contact pin to an insulator on said wire.

3. A contact pin according to claim 2 wherein said first pair of flanges each has a first width and said second pair of flanges each has a second width, where said first and second widths are selected to accommodate a plurality of different crimp tools.

4. A contact pin according to claim 1, wherein said plurality of protrusions comprises gimbals.

5. A contact pin according to claim 4, wherein said gimbals are circular.

6. A contact pin according to claim 1 wherein at least one of said plurality of protrusions is located on said body of said contact pin near said second end of said contact pin.

7. (canceled)

8. (canceled)

9. An assembly comprising:
a housing having first and second sides and a plurality of channels there through, wherein at least one of said channels has at least two ridges therein and at least two surfaces therein, said at least two surfaces being spaced from said at least two ridges;
a contact pin comprising a body, a first end for connecting to another contact, a second end for connecting to a wire, a plurality of tabs for engaging with said ridges in said housing when said contact pin is inserted into said at least one channel, and a plurality of gimbals protruding from said pin body for contacting with said at least two surfaces in said housing.

10. An assembly according to claim 9 including means for mounting the housing to an interface device for automatic test equipment.

11. An assembly according to claim 9 wherein said contact pin further comprises:
a first pair of flanges for contacting a conducting portion of the wire, and a second pair of flanges for connecting said contact pin to an insulator on said wire.

12. An assembly comprising:
a module having first and second sides and a plurality of channels there through, wherein at least one of said channels has means for engaging a plurality of locking tines of a contact pin and at least one surface therein;
a contact pin comprising a body, a first end for connecting to another contact, a second end for connecting to a wire, a plurality of locking tines located near a midpoint of said body for engaging with said means for engaging in said module when said contact pin is inserted to said at least one channel, and a protrusion from said pin body for contacting with said at least one surface in said module.

13. An assembly according to claim 12 wherein said contact pin further comprises:
a first pair of flanges for contacting a conducting portion of the wire and a second pair of flanges for connecting said contact pin to an insulator on said wire.

14. An assembly according to claim 12 wherein said means for engaging a plurality of locking tines comprises a plurality of ridges, recesses, lips, or grooves in said channel.

15. A contact pin according to claim 1 wherein said elongated body has first and second pairs of opposing sides; said first pair of opposing sides each having one of said tabs thereon and said second pair of opposing sides each having one of said protrusions thereon.
